(19) United States
(12) Patent Application Publication
(10) Pub. No.: US 2019/0036704 A1
(43) Pub. Date: Jan. 31, 2019

(54) SYSTEM AND METHOD FOR VERIFICATION OF A SECURE ERASE OPERATION ON A STORAGE DEVICE

(71) Applicant: Intel Corporation, Santa Clara, CA (US)

(72) Inventors: DOUG DeVETTER, Cameron Park, CA (US); JAMES CHU, Hillsboro, OR (US); ADRIAN PEARSON, Hillsboro, OR (US); GAMIL CAIN, El Dorado Hills, CA (US); SRIKANTH VARADARAJAN, Hillsboro, OR (US)

(73) Assignee: Intel Corporation, Santa Clara, CA (US)

(21) Appl. No.: 15/855,310

(22) Filed: Dec. 27, 2017

(51) Int. Cl. H04L 9/32; G06F 21/60; G06F 3/06; H04L 9/14; H04L 9/30

(52) U.S. Cl. CPC H04L 9/3247; G06F 21/602; G06F 3/0608; H04L 9/302; G06F 3/0659; G06F 3/0679; H04L 9/14; G06F 3/0652

(57) ABSTRACT

A system for verifying the secure erase of a storage device is provided. A storage device controller for the storage device logs the execution of a secure erase command. A storage device controller for the storage device receives an erase verify command from a host. The storage device controller retrieves one or more secure erase log entries from access-limited memory locations in non-volatile memory of the storage device. The storage device controller copies the one or more secure erase log entries to storage device buffer circuitry. The storage device controller secures the one or more secure erase log entries with one or more cryptographic keys to generate an encrypted and/or signed erase verification message. The storage device controller transmits the encrypted and/or signed erase verification message to the host, in response to receipt of the erase verify command.

### TECHNICAL FIELD

The present disclosure relates to systems and methods for verifying the secure erasure of storage devices.

### BACKGROUND

Storage devices implement a “secure erase” capability for data sanitization. While the sanitization method is generally effective, providing assurance that the command completed successfully can be difficult to prove and vulnerable to compromise. The completion notification can be spoofed and/or defeated by a myriad of software and hardware attacks between the caller and the storage device (e.g., a solid-state drive). Customers need evidence of the successful completion for a number of reasons, including compliance with certain industry standards.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is a schematic depicting an illustrative system for verifying the secure erase of a storage device, according to one embodiment;

FIG. 2 is a high-level logic flow diagram of an illustrative method for verifying the secure erase of a storage device, according to one embodiment;

FIG. 3 is a high-level logic flow diagram of an illustrative method for verifying the secure erase of a storage device, according to one embodiment; and

FIG. 4 is a high-level logic flow diagram of an illustrative method for verifying the secure erase of a storage device, according to one embodiment.

Although the following Detailed Description will proceed with reference being made to illustrative embodiments, many alternatives, modifications and variations thereof will be apparent to those skilled in the art.

### DETAILED DESCRIPTION

The system and method disclosed herein verify the completion of a secure erase of user accessible data in a storage device, according to one embodiment. Many industries such as financial industries and healthcare industries are required to perform a secure erase of storage devices (e.g., solid-state drives and/or hard disk drives) prior to repurposing the storage devices. The financial information, other personally identifiable information (“PII”), and healthcare information/records are considered sensitive information that may result in identity theft or other losses of privacy, if not disposed of carefully. As a result, some companies can charge a fee per storage device to erase storage devices. Even though a company may have a skilled and talented information technology (“IT”) team, this particular service is currently and painfully outsourced by many companies. The system and methods disclosed herein may enable in-house IT teams to recapture this important security operation (e.g., secure erasing and securely verifying the secure erasure of storage devices).

A storage device controller is configured to perform one or more operations to verify the secure erase of the storage device, according to one embodiment. The storage device controller for the storage device receives an erase verify command from a host, according to one embodiment. The storage device controller retrieves one or more secure erase log entries from access-limited memory locations in non-volatile memory (“NVM”) of the storage device, according to one embodiment. The storage device controller copies the one or more secure erase log entries to storage device buffer circuitry, according to one embodiment. The storage device controller digitally secures (e.g., signs and/or encrypts) the one or more secure erase log entries with one or more cryptographic keys (e.g., an encryption key or a signing key) to generate an encrypted and/or signed erase verification message, according to one embodiment. Securing the one or more secure erase log entries includes encrypting the one or more secure log entries with an encryption key, signing the one or more secure erase log entries with a signing key, or both encrypting and signing the one or more secure erase log entries, according to one embodiment. The storage device controller transmits the encrypted and/or signed erase verification message to the host, in response to receipt of the erase verify command, according to one embodiment.

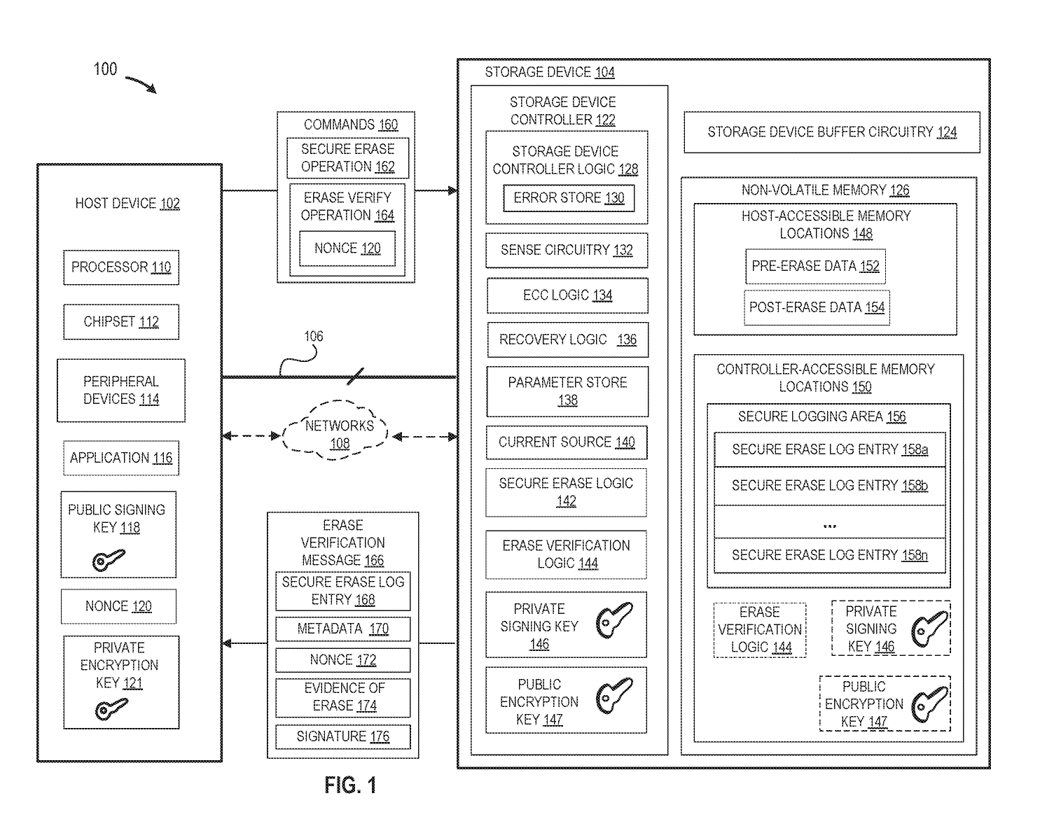

FIG. 1 depicts an illustrative system 100 to verify the secure erase of a storage device, according to one embodiment. The system 100 may correspond to: a computing device that includes, but is not limited to, a server, a workstation computer, a desktop computer, a laptop computer, a tablet computer (e.g., iPad®, GalaxyTab® and the like), an ultraportable computer, an ultramobile computer, a netbook computer and/or a subnotebook computer; and/or a mobile telephone including, but not limited to a smart phone, (e.g., iPhone®, Android®-based phone, Blackberry®, Symbian®-based phone, Palm®-based phone, etc.) and/or a feature phone.

The system may include a host device 102 and a storage device 104 communicatively and/or physically coupled together through one or more buses 106 using one or more of a variety of hardware/communications protocols including, but not limited to, SCSI (Small Computer System Interface), SAS (Serial Attached SCSI), PCIe (Peripheral Component Interconnect Express), NVMe (Non-Volatile Memory Express), SATA (Serial ATA (Advanced Technology Attachment)). The host device 102 may be remotely communicatively coupled to the storage device 104 through one or more networks 108. The one or more networks include, but are not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types;

The host device 102 may include a processor 110, a chipset 112, and peripheral devices 114, according to one embodiment. The processor 110, a chipset 112, and peripheral devices 114 may be communicatively and/or physically coupled together through the one or more buses 106, according to one embodiment. The processor 110 may correspond to a single core or a multi-core general purpose processor, such as those provided by Intel® Corporation, etc., according to one embodiment. The chipset 112 may include, for example, a set of electronic components that includes the one or more buses 106 to facilitate communication between components of the system. The chipset 112 may manage data flow between the processor 110, the peripheral devices 114, and the storage device 104. The peripheral devices 114 may include, for example, user interface device(s) including a display, a touch-screen display, a printer, a keypad, a keyboard, etc., wired and/or wireless communication logic, and additional storage device(s) including hard disk drives, solid-state drives, removable storage media, etc., according to one embodiment.

The host device may include an application 116, a public signing key 118, a nonce 120, and a private encryption key. The application 116 may be application that enables a user of the host device 102 to send erase commands to the storage device 104 and enables the user of the host device 102 to receive, verify, and/or read the encrypted and/or signed erase verification messages from the storage device 104, according to one embodiment. The application 116 may use a public signing key 118 to determine that a signature (e.g., a hash of the erase verification message) has not been changed during the communication path between the storage device 104 and the host device 102, according to one embodiment. The application 116 may transmit a nonce 120 with the erase commands that are transmitted to the storage device 104, as additional evidence of a secure erase operation being performed on the storage device 104, according to one embodiment. The nonce 120 is a word, a number, or other cryptographic identifier that can be sent, received, and verified, to reduce the likelihood of receiving replayed verification messages (e.g., in the case that the storage device 104 has been compromised). The application 116 may use a private encryption key 121 to decrypt the erase verification message, if the erase verification message has, optionally, been encrypted (e.g., with a public encryption key that the private encryption key 121 may decrypt), according to one embodiment.

The storage device 104 is configured to receive instructions, addresses, data, and commands from the processor 110, and to provide data and messages to the processor 110, over the one or more buses 106, according to one embodiment. The storage device 104 may be a system having one or more storage device controllers and one or more non-volatile memory devices, according to one embodiment. The storage device 104 may be a solid-state drive (“SSD”) that includes a number of non-volatile memory dice configured as one or more memory arrays, according to one embodiment. The storage device 104 may be a hard disk drive (“HDD”) that includes a spinning non-volatile memory media, according to one embodiment. The storage device 104 may be a hybrid of a solid-state drive and a hard disk drive, according to one embodiment.

The storage device 104 includes a storage device controller 122, storage device buffer circuitry 124, and non-volatile memory 126, according to one embodiment. The storage device controller 122, the storage device buffer circuitry 124, and the non-volatile memory 126 enable the storage device 104 to securely erase the non-volatile memory 126, to store secure erase log entries, and to generate and transmit encrypted and/or signed erase verification messages that enable the host device 102 to securely verify that certain portions of the non-volatile memory 126 have been securely erased, according to one embodiment.

The storage device controller 122 is configured to address, write to and read from, the non-volatile memory 126, according to one embodiment. The storage device controller 122 is configured to perform memory access operations (e.g., reading a target memory cell and/or writing to a target memory cell), error correction code (“ECC”) check operations, and memory cell recovery operations, according to one embodiment. The storage device controller 122 may include various logic, circuitry, and/or modules to facilitate storage device operation operations and communication with one or more of the processor 110, the chipset 112, the peripheral devices 114, and the application 116, according to one embodiment. The storage device controller 122 may include one or more of storage device controller logic 128, an error store 130, sense circuitry 132, ECC logic 134, recovery logic 136, a parameter store 138, and/or a current source 140, for reading, writing, or otherwise accessing portions of the non-volatile memory 126, according to one embodiment. The storage device controller logic 128 may configured to perform operations associated with storage device controller 122. For example, the storage device controller logic 128 may manage communications with the processor 110 and may be configured to identify one or more target memory cells, target memory blocks, or target sectors associated with each received memory address (e.g., in a read request). The error store 130 includes a fail type for failed memory read or access operations, according to one embodiment. The sense circuitry 132 may be configured to detect a quantity of current passing through a memory cell (e.g., during a read operation of non-volatile memory), according to one embodiment. The ECC logic 134 is configured to provide error checking functionality for the storage device controller 122, according to one embodiment. The recovery logic 136 is configured to manage recovery of fail operations for associated memory cells, memory blocks, and/or the memory sectors identified by ECC logic 134 and/or storage device controller logic 128, according to one embodiment. The parameter store 138 is configured to store the number of adjacent memory cells (e.g., for the non-volatile memory 126 in an SSD implementation) to select and parameters associated with a sequence of recovery pulses, to facilitate error correction. The number of adjacent memory cells to select may be based, at least in part, on fail type, memory array density, and/or maximum current available from the current source 140, according to one embodiment. The current source 140 supplies current to one or more portions of the non-volatile memory 126, according to one embodiment.

The storage device controller 122 may include logic and components to support secure erase operations and secure erase verification operations. The storage device controller 122 includes secure erase logic 142, erase verification logic 144, a private signing key 146, and a public encryption key 147, to support secure erase operations and/or secure erase verification operations, according to one embodiment.

The secure erase logic 142 includes instructions, which when executed by the storage device controller 122, cause the storage device controller 122 to erase portions of the non-volatile memory 126, according to one embodiment. The secure erase logic 142 may be stored in firmware of the storage device controller 122. The storage device controller 122 may use one or more of a number of techniques for erasing the non-volatile memory 126, according to one embodiment. For example, if the non-volatile memory 126 includes solid state non-volatile memory or electronically erasable memory, the secure erase logic 142 may include instructions for applying a voltage to memory cells of the non-volatile memory 126 to cause the memory cells to be reprogrammed to an erased state. More specifically, the host 102 may transmit a ‘format NVM’ command to the storage device 104 (e.g., using the NVMe over PCIe protocol). The ‘format NVM’ command may instruct the storage device controller to perform a User Data Erase operation (e.g., to erase all user content present in the non-volatile memory 126) or a Cryptographic Erase operation (e.g., to effectively erase all user content in the non-volatile memory 126 by erasing an encryption key with which all user content was encrypted). As another example, if the non-volatile memory 126 includes disk media (e.g., a hard disk drive), the secure erase logic 142 may include instructions for erasing, over-writing, encrypting, and/or otherwise destroying contents of a file allocation table (or its equivalent) so that the information stored on the disk media is illegible or otherwise rendered meaningless to subsequent read attempts. For example, the host 102 may transmit a ‘Secure Erase’ command that is built into firmware of hard disk drives. The ‘Secure Erase’ command writes logic ‘0’ to the entire disk or to host-accessible portions of a hard disk drive. In some embodiments, a secure erase of a hard disk drive may include performing a ‘Secure Erase’ operation multiple times (e.g., 3-5 times) to decrease the likelihood of recovering information from a hard disk drive.

The secure erase logic 142 is configured to create one or more secure erase log entries in portions of the non-volatile memory 126 that are limited in access, such that the storage device controller 122 may access the secure erase log entries and the host device 102 may not directly access the secure erase log entries, according to one embodiment. The secure erase logic 142 generates the one or more secure erase log entries after performing a secure erase or a crypto-erase on all or part of the non-volatile memory 126, according to one embodiment.

The erase verification logic 144 includes instructions that cause the storage device controller 122 to verify that the non-volatile memory 126 has been securely erased, according to one embodiment. The erase verification logic 144 may be stored in firmware of the storage device controller 122, according to one embodiment. The erase verification logic 144 may be stored in controller-accessible memory locations 150 of the non-volatile memory 126, according to one embodiment. The erase verification logic 144 includes instructions that cause the storage device controller 122 to access one or more stored secure erase log entries, copy the one or more stored secure erase log entries to the storage device buffer circuitry 124, and encrypt and/or digitally sign the one or more stored secure erase log entries as an encrypted and/or signed erase verification message, according to one embodiment. The erase verification logic 144 causes the storage device controller 122 to transmit the encrypted and/or signed erase verification message to the host device 102, in response to receiving an erase verify command from the host device 102, according to one embodiment. The erase verification logic 144 causes the storage device controller 122 to use a private signing key 146 to hash one or more of the secure erase log entries to generate a signature that is verifiable by the host device 102 with the public signing key 118, according to one embodiment. The erase verification logic 144 causes the storage device controller 122 to use a public encryption key 147 to optionally encrypt the one or more secure erase log entries, prior to transmission to the host device 102, according to one embodiment. The private signing key 146 is an encryption key that may be stored in the storage device using one of a number of techniques, according to various embodiments. For example, the private signing key 146 may be programmed into the storage device controller logic 128 (e.g., firmware for the storage device controller 122), according to one embodiment. As another example, the private signing key 146 may be hardcoded into one or more fuses during the manufacture of the storage device 104, according to one embodiment. The private signing key 146 may be copied into the controller-accessible memory locations 150 during the manufacture of the storage device 104, according to one embodiment. During the manufacture of a number of storage devices for a single, for example, enterprise purchaser, purchaser of the storage devices, a manufacturer may program or hardcode a number of private signing keys that may all be decrypted with the same public signing key 118, to enable information-technology administrators to conveniently verify the secure erase of the purchased storage devices, according to one embodiment. In one embodiment, the private signing key 146 is a first encryption key and the public signing key 118 is a second encryption key that may be used to decrypt information that is encrypted by the first encryption key. Although the private signing key 146 and the public signing key 118 are described as a private-public encryption key pair, other types of public key infrastructure (“PKI”) key pairs may be used to perform the erase verify operation, according to one embodiment.

The public encryption key 147 may be programmed into the firmware and/or hardware of the storage device 104 using similar techniques as may be used for the private signing key 146, according to one embodiment. In one embodiment, the public encryption key 147 is sent to the storage device 104 from the host device 102 after the storage device is installed into or is allocated for use by the host device 102.

The erase verification logic 144 may include instructions for applying one or more of a number of encryption/cryptographic techniques to one or more secure erase log entries, to encrypt and/or sign the one or more secure erase log entries, according to various embodiments. For example, the erase verification logic 144 may employ one or more of data encryption standard (“DES”), Blowfish, advanced encryption standard (“AES”), Twofish, international data encryption algorithm (“IDEA”), message digest 5 (“MD5”), secure hash algorithm 1 (“SHA1”), hash-based message authentication code (“HMAC”), the elliptic curve direct anonymous attestation (“ECDAA”) technique, or a Rivest-Shamir-Adleman (“RSA”) cryptographic technique, according to one embodiment. ECDAA is a form of digital signature that enables the storage device 104 to generate a cryptographically verifiable signature while maintaining anonymity. The use of an ECDAA protocol/technique enables the private signing key 146 to be provisioned (e.g., at manufacturing time) in each of a number of storage devices (e.g., the storage device 104) that can be used to generate signatures that are verifiable using a single group public key (e.g., the public signing key 118). This technique enables host software (e.g., the application 116) to verify storage device signatures for any storage device within a direct anonymous attestation (“DAA)” group using a single group public key. As result, use of ECDAA by the erase verification logic 144 may greatly reduce the number of public keys that are to be maintained by the host device 102, according to one embodiment.

The storage device buffer circuitry 124 may be volatile memory, non-volatile memory, and/or combination volatile memory and non-volatile memory, according to one embodiment. The storage device buffer circuitry 124 is configured to facilitate the transmission of data between the host device 102 and the storage device 104, according to one embodiment. The storage device buffer circuitry 124 includes volatile memory such as dynamic random-access memory (“DRAM”) and/or static random-access memory (“SRAM”), according to one embodiment. The storage device buffer circuitry 124 includes non-volatile memory cells (e.g., NAND memory), according to one embodiment. The storage device buffer circuitry 124 may also include future generation non-volatile devices, such as a three dimensional crosspoint memory device, or other byte addressable write-in-place non-volatile memory devices. In one embodiment, the storage device buffer circuitry 124 may include memory devices that use chalcogenide glass, multi-threshold level NAND non-volatile memory, NOR non-volatile memory, single or multi-level Phase Change Memory (“PCM”), a resistive memory, nanowire memory, ferroelectric transistor random access memory (“FeTRAM”), anti-ferroelectric memory, magnetoresistive random access memory (“MRAM”) memory that incorporates memristor technology, resistive memory including the metal oxide base, the oxygen vacancy base and the conductive bridge Random Access Memory (“CB-RAM”), or spin transfer torque (“STT”)-MRAM, a spintronic magnetic junction memory based device, a magnetic tunneling junction (“MTJ”) based device, a Domain Wall (“DW”) and Spin Orbit Transfer (“SOT”) based device, a thyristor based memory device, or a combination of any of the above.

The non-volatile memory 126 is a storage medium that does not require power to maintain the state of data stored by the storage medium, according to one embodiment. The non-volatile memory 126 may include, but is not limited to, a NAND non-volatile memory (e.g., Single-Level Cell (“SLC”), Multi-Level Cell (“MLC”), Tri-Level Cell (“TLC”), Quad-Level Cell (“QLC”), or some other NAND non-volatile memory type), NOR memory, solid-state memory (e.g., planar or three-dimensional (“3D”) NAND non-volatile memory or NOR non-volatile memory), storage devices that use chalcogenide phase change material (e.g., chalcogenide glass), byte addressable non-volatile memory devices, ferroelectric memory, silicon-oxide-nitride-oxide-silicon (“SONOS”) memory, polymer memory (e.g., ferroelectric polymer memory), byte addressable random accessible 3D XPoint (or crosspoint) memory, ferroelectric transistor random access memory (“Fe-TRAM”), magnetoresistive random access memory (“MRAM”), phase change memory (“PCM”, “PRAM”), resistive memory, ferroelectric memory (“F-RAM”, “FeRAM”), spin-transfer torque memory (“STT”), thermal assisted switching memory (“TAS”), millipede memory, floating junction gate memory (“FJG RAM”), magnetic tunnel junction (“MTJ”) memory, electrochemical cells (“ECM”) memory, binary oxide filament cell memory, interfacial switching memory, battery-backed RAM, ovonic memory, nanowire memory, electrically erasable programmable read-only memory (“EEPROM)”, etc. In some embodiments, the byte addressable random accessible 3D crosspoint memory may include a transistor-less stackable cross point architecture in which memory cells sit at the intersection of words lines and bitlines and are individually addressable and in which bit storage is based on a change in bulk resistance, in accordance with various embodiments.

The non-volatile memory 126 includes host-accessible memory locations 148 and controller-accessible memory locations 150, according to one embodiment. The non-volatile memory 126 may include solid-state memory, spinning disk media, and a combination of solid-state media and spinning disk media. The host-accessible memory locations 148 includes one or more blocks, sectors, locations, or portions of the non-volatile memory 126 that are accessible to the host device 102 or to some other device that is external to the storage device 104, according to one embodiment. The controller-accessible memory locations 150 includes restricted or reserved blocks, sectors, locations, or portions of the non-volatile memory 126 that may be read from and/or written to by the storage device controller 122 and not by the host device 102, according to one embodiment.

The host-accessible memory locations 148 store pre-erase data 152 and post-erase data 154, according to one embodiment. The pre-erase data 152 represents data that is stored in the host-accessible memory locations 148 during normal operation of the non-volatile memory 126, according to one embodiment. For example, the pre-erase data 152 may include, but is not limited to, pictures, audio, video, other multimedia content, personally identifiable information (“PII”), the financial data, healthcare information, email messages, etc. The post-erase data 154 represents the values stored in the same locations as the pre-erase data 152, but represents the value stored in those locations after the host-accessible memory locations 148 have been securely erased by the storage device controller 122, according to one embodiment. A portion of the pre-erase data 152 and a portion of the post-erase data 154 may be included in an encrypted and/or signed erase verification message that is sent from the storage device 104 to the host device 102, in response to an erase verify command, according to one embodiment.

The controller-accessible memory locations 150 include, among other things, a secure logging area 156, in which the secure erase logic 142 causes the storage device controller 122 to store one or more secure erase log entries, according to one embodiment. The controller-accessible memory locations 150 may include solid-state memory locations within the storage device controller 122, according one embodiment. The controller-accessible memory locations 150 may include reserved solid-state memory locations within a solid-state memory cell array, according one embodiment. The controller-accessible memory locations 150 may include one or more portions (e.g., sectors) within spinning disk media, according one embodiment. The secure logging area 156 includes a secure erase log entry 158a, and a secure erase log entry 158b through a secure erase log entry 158n, which is representative of an undefined number of secure erase log entries (cumulatively, secure erase log entries 158), according to one embodiment. Each of the secure erase log entries 158 may include metadata, such as timestamp information, a number of memory blocks erased, a number of memory sectors erased, the length of time that the erase operation consumed, an identifier of how many times the non-volatile memory 126 has been securely erased, a portion of the pre-erase data 152 and a portion of the post-erase data 154 as evidence of erasure, etc. The secure erase log entries 158 are written to the secure logging area 156 by the storage device controller 122 executing the secure erase logic 142, according to one embodiment. The secure erase logic 142 causes the storage device controller 122 to encrypt the secure erase log entries 158 with the public encryption key 147, according to one embodiment. In another embodiment, the secure erase log entries 158 are encrypted in response to receipt of an erase verify command and are not encrypted during a secure erase operation. The secure erase logic 142 causes the storage device controller 122 to generate a signature for the secure erase log entries 158 with the private signing key 146, according to one embodiment. In another embodiment, the secure erase log entries 158 are signed in response to receipt of an erase verify command and are not signed during the secure erase operation.

The controller-accessible memory locations 150 optionally includes the private signing key 146, the public encryption key 147, and the erase verification logic 144, according to one embodiment.

In operation, consistent with embodiments of the present disclosure, the host device 102 transmits one or more commands 160 to the storage device 104, to cause the storage device 104 to perform a secure erase operation 162 and/or an erase verify operation 164. The erase verify operation 164 may include the nonce 120, according to one embodiment. The one or more commands 160 may be transmitted concurrently to the storage device 104, or the secure erase operation 162 and the erase verify operation 164 may be transmitted at different times (e.g., at a later date from each other), according to one embodiment.

In response to receipt of the one or more commands 160, the storage device controller 122 executes the secure erase logic 142 and/or the erase verification logic 144 to erase the host-accessible memory locations 148, to store one or more secure erase log entries 158 in the controller-accessible memory locations 150, to encrypt one or more of the secure erase log entries 158, to generate a signature for one or more of the secure erase log entries, and to generate and transmit an erase verification message 166 for the host device 102.

The erase verification message 166 may include a secure erase log entry 168, metadata 170, a nonce 172, evidence of erase 174, and a signature 176, according to one embodiment. The erase verification message 166 may be encrypted, may be signed, or may be both encrypted and signed, according to one embodiment. If the erase verification message 166 is encrypted, the erase verification message 166 may be encrypted with the public encryption key 147 (which may be decrypted with the private encryption key 121), according to one embodiment. The secure erase log entry 168 may be one or more of the secure erase log entries 158, according to one embodiment. The metadata 170 may include, but is not limited to, one or more of a timestamp, a quantity of memory that was erased, the number of secure erase operations performed on the storage device 104, etc. The nonce 172 may be the nonce 120, which the host device 102 may use to verify an integrity of the storage device 104, according to one embodiment. The evidence of erase 174 may include, but is not limited to, a portion of the pre-erase data 152 and a portion of the post-erase data 154, to show that one or more particular memory locations have been erase, according to one embodiment. The portion of the pre-erase data 152 may be encrypted so that PII or other personal information is not transmitted to the host device 102, according to one embodiment. The signature 176 may be a hash of one or more portions of the erase verification message 166. The signature 176 is a hash (e.g., using the private signing key 146) of the secure erase log entry 168, according to one embodiment. The signature 176 is a hash (e.g., using the private signing key 146) of one or more of the secure erase log entry 168, the metadata 170, the nonce 172, and the evidence of erase 174, according to one embodiment.

The host device 102 may perform the secure erase operation 162 and/or the erase verify operation 164 through the one or more buses 106 and/or through the one or more networks 108, according to one embodiment. That is, the host device 102 may be remotely located from the storage device 104 and may perform one or more of the disclosed operations through one or more of the networks 108, to enable an information technology administrator to remotely and securely wipe a number of storage devices, according to one embodiment.

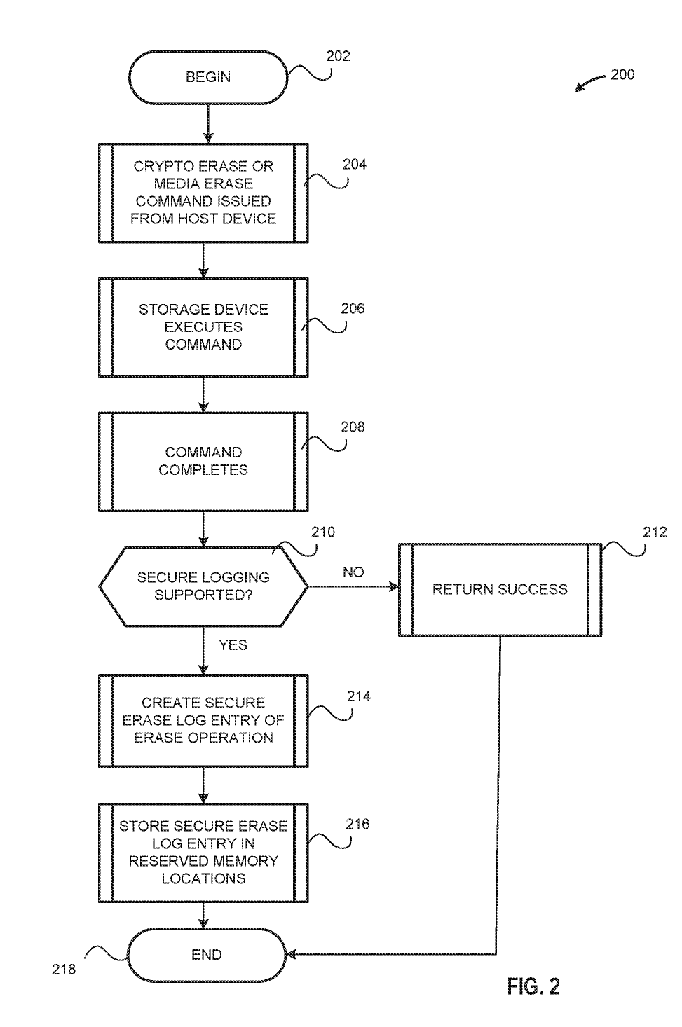

FIG. 2 is a high-level logic flow diagram of an illustrative method 200 for verifying the secure erase of a storage device, in accordance with at least one embodiment described herein. The method 200 includes one or more operations that may be performed on the system 100 (shown in FIG. 1), according to one embodiment.

At operation 202, method 200 begins. Operation 202 may proceed to operation 204.

At operation 204, the method 200 includes issuing a crypto erase or a media erase command from a host device, according to one embodiment. Crypto erase may refer to reverting an OPAL-activated or eDrive-activated SSD back to its factory default state. After a crypto erase, all security keys may be deleted, and user data may be destroyed. If OPAL or eDrive becomes deactivated, the drive may be reused with any compatible security application. A non-volatile memory format command may include erasing memory cells to an erase state. If the non-volatile memory includes a hard disk drive, the crypto erase or the non-volatile memory format command may include writing over file allocation tables and/or various sectors of the disc media. Operation 204 may proceed to operation 206.

At operation 206, the method 200 includes the storage device executing the command, according to one embodiment. Executing the command may include, but is not limited to, a storage device controller executing secure erase logic, according to one embodiment. Operation 206 may proceed to operation 208.

At operation 208, the method 200 includes the storage device completing the command, according to one embodiment. Operation 208 may proceed to operation 210.

At operation 210, the method 200 includes determining whether secure logging is supported by the storage device, according to one embodiment. If secure logging is not supported, operation 210 may proceed to operation 212. If secure logging is supported, operation 210 may proceed to operation 214.

At operation 212, the method 200 returns a message that the erase command has been successfully completed, according to one embodiment. Operation 212 may proceed to operation 218 where the method 200 ends.

At operation 214, the method 200 creates a secure erase log entry of the erase operation, according to one embodiment. Operation 214 may proceed to operation 216, according to one embodiment.

At operation 216, the method 200 stores the secure erase log entry in reserved memory locations, according to one embodiment. The reserved memory locations may be accessible by the storage device (e.g., by the storage device controller), and may be inaccessible by the host device or by any other computing device that is external to the storage device, according to one embodiment. Storing the secure erase log entry enables a storage device controller to access the secure erase log entry immediately after creation/storage, or at some later date, according to one embodiment. Operation 216 may proceed to operation 218, where the method 200 ends.

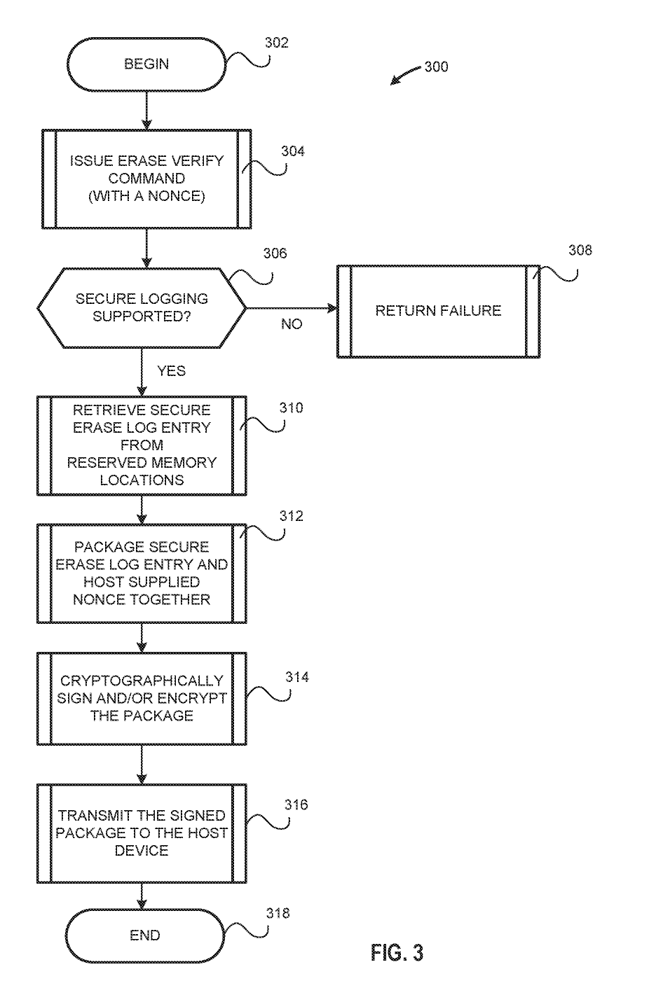

FIG. 3 is a high-level logic flow diagram of an illustrative method 300 for verifying the secure erase of a storage device, in accordance with at least one embodiment described herein.

At operation 302, the method 300 begins. Operation 302 may proceed to operation 304.

At operation 304, the method 300 includes a host device issuing an erase verify command to a storage device, according to one embodiment. The erase verify command may include a nonce, according to one embodiment. Operation 304 may proceed to operation 306, according to one embodiment.

At operation 306, the method 300 determines if secure logging is supported, according to one embodiment. If secure logging is not supported, operation 306 may proceed to operation 308. If secure logging is supported, operation 306 may proceed to operation 310.

At operation 308, the method 300 includes the storage device returning a failure message, according to one embodiment. The storage device may return a failure message when the storage device does not support secure logging and cannot perform an erase verify operation, according to one embodiment. Operation 308 may proceed to operation 318, where the method 300 ends.

At operation 310, the method 300 includes the storage device retrieving a secure erase log entry from the reserved memory locations, according to one embodiment. Operation 310 may proceed to operation 312.

At operation 312, the method 300 includes the storage device packaging the secure erase log entry and the optional host-supplied nonce together, according to one embodiment. Operation 312 may proceed to operation 314.

At operation 314, the method 300 includes the storage device cryptographically signing and/or encrypting the package, according to one embodiment. Cryptographically signing the package may include applying one or more cryptographic signing algorithms to the package using a private signing key, according to one embodiment. The package may also be partially or entirely encrypted using one or more encryption keys and encryption algorithms, according to one embodiment. Operation 314 may proceed to operation 316.

At operation 316, the method 300 includes the storage device transmitting the cryptographically signed package to the host device, according to one embodiment. Operation 316 proceeds to operation 318, where the method 300 ends.

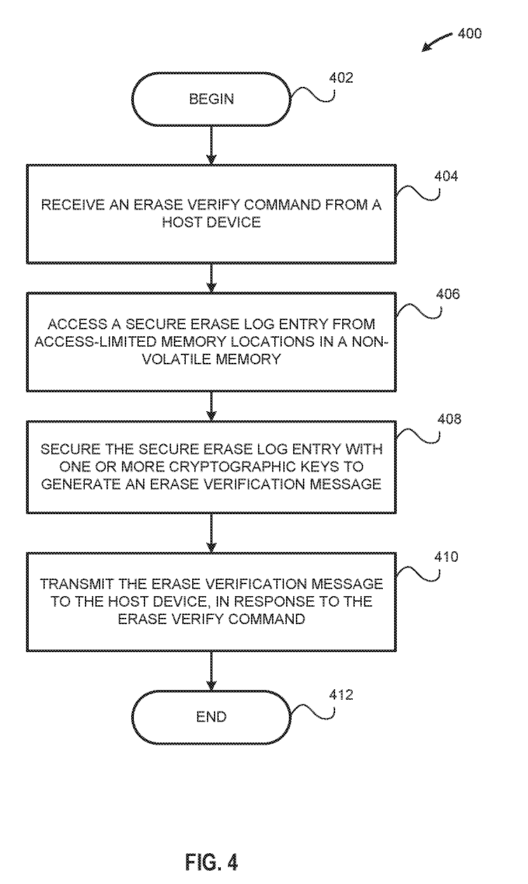

FIG. 4 is a high-level logic flow diagram of an illustrative method 400 for verifying the secure erase of a storage device, in accordance with at least one embodiment described herein.

At operation 402, the method 400 begins. Operation 402 may proceed to operation 404.

At operation 404, the method 400 includes receiving an erase verify command from a host device, according to one embodiment. Operation 404 may proceed to operation 406.

At operation 406, the method 400 includes accessing a secure erase log entry from an access-limited memory location in a non-volatile memory, according to one embodiment. Operation 406 may proceed to operation 408.

At operation 408, the method 400 includes securing the secure erase log with one or more cryptographic keys to form an erase verification message, according to one embodiment.

Securing the secure erase log includes encrypting and/or signing the secure erase log, according to one embodiment. The one or more cryptographic keys include an encryption key and/or a signing key. Operation 408 may proceed to operation 410.

At operation 410, the method 400 includes transmitting the erase verification message to the host device, in response to the erase verify command, according to one embodiment. Operation 410 may proceed to operation 412.

At operation 412, the method 400 ends.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. The embodiments are not limited to this context.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment”, “an embodiment”, or “an implementation” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, within the storage device controller 122 that executes code and/or instructions sets (e.g., software, firmware, etc.) corresponding to the functionality described herein, thus transforming a general-purpose processor into a specific-purpose processing environment to perform one or more of the operations described herein. In some embodiments, the various components and circuitry of the storage device controller circuitry or other systems may be combined in a system-on-a-chip (“SoC”) architecture.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (“CD-ROMs”), compact disk rewritables (“CD-RWs”), and magneto-optical disks, semiconductor devices such as read-only memories (“ROMs”), random access memories (“RAMs”) such as dynamic and static RAMs, erasable programmable read-only memories (“EPROMs”), electrically erasable programmable read-only memories (“EEPROMs”), non-volatile memories, magnetic or optical cards, or any type of storage devices suitable for storing electronic instructions.

In some embodiments, a hardware description language (“HDL”) may be used to specify circuit and/or logic implementation(s) for the various logic and/or circuitry described herein. For example, in one embodiment the hardware description language may comply or be compatible with a very high speed integrated circuits (“VHSIC”) hardware description language (“VHDL”) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (“HDL”) may be used to specify circuit and/or logic implementation(s) for the various logic and/or circuitry described herein. For example, in one embodiment, the HDL may comply or be compatible with IEEE standard 62530-2011: SystemVerilog—Unified Hardware Design, Specification, and Verification Language, dated Jul. 7, 2011; IEEE Std 1800™-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

### EXAMPLES

Examples of the present disclosure include subject material such as a storage device controller, a method, and a system related to verification of secure erase operations for storage devices, as discussed below.

### Example 1

According to this example there is provided a storage device controller. The storage device controller may include storage device controller logic that may receive an erase verify command from a host device; and may transmit an erase verification message to the host device, in response to the erase verify command. The storage device controller may include erase verification logic that may access a secure erase log entry from access-limited memory locations in a non-volatile memory; and that may secure the secure erase log entry with one or more cryptographic keys to generate the erase verification message.

### Example 2

This example includes the elements of example 1, wherein the storage device controller logic may receive a secure erase command from a host device; erase host-accessible memory locations in the non-volatile memory; generate the secure erase log entry; and store the secure erase log entry in the access-limited memory locations in the non-volatile memory.

### Example 3

This example includes the elements of example 1, wherein the secure erase log entry includes metadata, wherein the metadata includes one or more of a timestamp, a size of memory locations the erased, or a number of secure erase operations performed.

### Example 4

This example includes the elements of example 1, wherein secure the secure erase log entry includes encrypt and/or sign the secure erase log entry, wherein the one or more cryptographic keys include at least one of a private signing key and a public encryption key, wherein the private signing key is to sign one or more portions of the erase verification message and is programmed into storage device controller firmware or programmed into fuses for a storage device during a manufacture of the storage device controller or the storage device, wherein the public encryption key is to encrypt one or more portions of the erase verification message.

### Example 5

This example includes the elements of example 1, wherein the one or more cryptographic keys and the erase verification logic are stored in the access-limited memory locations in the non-volatile memory.

### Example 6

This example includes the elements of example 1, wherein the erase verification logic is programmed into firmware of the storage device controller during a manufacture of the storage device controller.

### Example 7

This example includes the elements of example 1, wherein the erase verify command includes a nonce from the host device, wherein the erase verification message includes the nonce as evidence of an absence of replay attack compromise of the storage device controller.

### Example 8

This example includes the elements of example 1, wherein the erase verification logic secures the secure erase log entry by encrypting and/or signing the secure erase log using one or more of DES, Blowfish, AES, Twofish, IDEA, MD5, SHA1, HMAC, an elliptic curve direct anonymous attestation technique, or a Rivest-Shamir-Adleman (“RSA”) cryptographic technique.

### Example 9

This example includes the elements of example 1, wherein the erase verification message includes pre-erase data copied from host-accessible memory locations in the non-volatile memory and post-erase data copied from the host-accessible memory locations in the non-volatile memory.

### Example 10

According to this example there is provided a storage device. The storage device may include storage device buffer circuitry; non-volatile memory having host-accessible memory locations and access-limited memory locations; and a storage device controller communicatively coupled to the non-volatile memory. The storage device controller may include storage device controller logic that may receive an erase verify command from a host device; and transmit an erase verification message to the host device, in response to the erase verify command. The storage device controller may include erase verification logic that may access a secure erase log entry from the access-limited memory location in the non-volatile memory; and secure the secure erase log entry with one or more cryptographic keys to generate the erase verification message.

### Example 11

This example includes the elements of example 10, wherein the storage device controller logic may receive a secure erase command from a host device; erase host-accessible memory locations in the non-volatile memory; generate the secure erase log entry; and store the secure erase log entry in the access-limited memory locations in the non-volatile memory.

### Example 12

This example includes the elements of example 10, wherein the secure erase log entry includes metadata, wherein the metadata includes one or more of a timestamp, a size of memory locations the erased, or a number of secure erase operations performed.

### Example 13

This example includes the elements of example 10, wherein secure the secure erase log entry include encrypt and/or sign the secure erase log entry, wherein the one or more cryptographic keys include at least one of a private signing key and a public encryption key, wherein the private signing key is to sign one or more portions of the erase verification message and is programmed into storage device controller firmware or programmed into fuses for a storage device during a manufacture of the storage device controller or the storage device, wherein the public encryption key is to encrypt one or more portions of the erase verification message.

### Example 14

This example includes the elements of example 10, wherein the one or more cryptographic keys and the erase verification logic are stored in the access-limited memory locations in the non-volatile memory.

### Example 15

This example includes the elements of example 10, wherein the erase verification logic is programmed into firmware of the storage device controller during a manufacture of the storage device controller.

### Example 16

This example includes the elements of example 10, wherein the non-volatile memory is solid-state memory, hard disk media, or a combination of solid-state memory and hard disk media.

### Example 17

This example includes the elements of example 10, wherein the erase verification logic secures the secure erase log entry by encrypting and/or signing the secure erase log using one or more of DES, Blowfish, AES, Twofish, IDEA, MD5, SHA1, HMAC, an elliptic curve direct anonymous attestation technique, or a Rivest-Shamir-Adleman (“RSA”) cryptographic technique.

### Example 18

This example includes the elements of example 10, wherein the erase verification message includes pre-erase data copied from host-accessible memory locations in the non-volatile memory and post-erase data copied from the host-accessible memory locations in the non-volatile memory.

### Example 19

According to this example there is provided a computer readable storage device having stored thereon instructions that when executed by one or more processors result in operations. The operations may include receive an erase verify command from a host device; access a secure erase log entry from access-limited memory locations in a non-volatile memory, wherein the access-limited memory locations are accessible by a storage device controller and are inaccessible by the host device; secure the secure erase log entry with one or more cryptographic keys to form an erase verification message; and transmit the erase verification message to the host device, in response to the erase verify command.

### Example 20

This example includes the elements of example 19, wherein the operations may further include receive a secure erase command from a host device; erase host-accessible memory locations in the non-volatile memory; generate the secure erase log entry; and store the secure erase log entry in the access-limited memory locations in the non-volatile memory.

### Example 21

This example includes the elements of example 19, wherein the secure erase log entry includes metadata, wherein the metadata includes one or more of a timestamp, a size of memory locations the erased, or a number of secure erase operations performed.

### Example 22

This example includes the elements of example 19, wherein the operations may include: read the one or more cryptographic keys from a plurality of fuses or from firmware for the storage device controller, wherein the one or more cryptographic keys include a private signing key and a public encryption key.

### Example 23

This example includes the elements of example 19, wherein secure the secure erase log entry may include: copy the secure erase log entry to storage device buffer circuitry; and apply the one or more cryptographic keys to the secure erase log entry to encrypt and/or sign the secure erase log entry, using an encryption algorithm and/or a signing algorithm.

### Example 24

This example includes the elements of example 19, wherein the operations may include: receive a nonce from the host device with the erase verify command; and include the nonce in the erase verification message, to enable the host to verify an absence of replay attack compromise of the storage device controller.

### Example 25

This example includes the elements of example 19, wherein secure the secure erase log entry includes use of one or more of DES, Blowfish, AES, Twofish, IDEA, MD5, SHA1, HMAC, an elliptic curve direct anonymous attestation technique, or a Rivest-Shamir-Adleman (“RSA”) cryptographic technique.

### Example 26

According to this example there is provided a method. The method may include receiving an erase verify command from a host device; accessing a secure erase log entry from access-limited memory locations in a non-volatile memory, wherein the access-limited memory locations are accessible by a storage device controller and are inaccessible by the host device; securing the secure erase log entry with one or more cryptographic keys to form an erase verification message; and transmitting the erase verification message to the host device, in response to the erase verify command.

### Example 27

This example includes the elements of example 26, further including: receiving a secure erase command from a host device; erasing host-accessible memory locations in the non-volatile memory; generating the secure erase log entry; and storing the secure erase log entry in the access-limited memory locations in the non-volatile memory.

### Example 28

This example includes the elements of example 26, wherein the secure erase log entry includes metadata, wherein the metadata includes one or more of a timestamp, a size of memory locations the erased, or a number of secure erase operations performed.

### Example 29

This example includes the elements of example 26, further including: reading the one or more cryptographic keys from a plurality of fuses or from firmware for the storage device controller, wherein the one or more cryptographic keys include a private signing key and a public encryption key.

### Example 30

This example includes the elements of example 26, wherein securing the secure erase log entry includes: copying the secure erase log entry to storage device buffer circuitry; and applying the one or more cryptographic keys to the secure erase log entry to encrypt and/or sign the secure erase log entry, using an encryption algorithm and/or a signing algorithm.

### Example 31

This example includes the elements of example 26, further including: receiving a nonce from the host device with the erase verify command; and including the nonce in the erase verification message, to enable the host to verify an absence of replay attack compromise of the storage device controller.

### Example 32

This example includes the elements of example 26, wherein securing the secure erase log entry includes using of one or more of DES, Blowfish, AES, Twofish, IDEA, MD5, SHA1, HMAC, an elliptic curve direct anonymous attestation technique, or a Rivest-Shamir-Adleman (“RSA”) cryptographic technique.

### Example 33

According to this example there is provided a storage device controller. The storage device controller may include: means for receiving an erase verify command from a host device; means for accessing a secure erase log entry from access-limited memory locations in a non-volatile memory, wherein the access-limited memory locations are accessible by a storage device controller and are inaccessible by the host device; means for securing the secure erase log entry with one or more cryptographic keys to form an erase verification message; and means for transmitting the erase verification message to the host device, in response to the erase verify command.

### Example 34

This example includes the elements of example 33, further including: means for receiving a secure erase command from a host device; means for erasing host-accessible memory locations in the non-volatile memory; means for generating the secure erase log entry; and means for storing the secure erase log entry in the access-limited memory locations in the non-volatile memory.

### Example 35

This example includes the elements of example 33, wherein the secure erase log entry includes metadata, wherein the metadata includes one or more of a timestamp, a size of memory locations the erased, or a number of secure erase operations performed.

### Example 36

This example includes the elements of example 33, further including: means for reading the one or more cryptographic keys from a plurality of fuses or from firmware for the storage device controller, wherein the one or more cryptographic keys include a private signing key and a public encryption key.

### Example 37

This example includes the elements of example 33, wherein means for securing the secure erase log entry includes: means for copying the secure erase log entry to storage device buffer circuitry; and means for applying the one or more cryptographic keys to the secure erase log entry to encrypt and/or sign the secure erase log entry, using an encryption algorithm and/or a signing algorithm.

### Example 38

This example includes the elements of example 33, further including: means for receiving a nonce from the host device with the erase verify command; and means for including the nonce in the erase verification message, to enable the host to verify an absence of replay attack compromise of the storage device controller.

### Example 39

This example includes the elements of example 33, wherein securing the secure erase log entry includes using of one or more of DES, Blowfish, AES, Twofish, IDEA, MD5, SHA1, HMAC, an elliptic curve direct anonymous attestation technique, or a Rivest-Shamir-Adleman (“RSA”) cryptographic technique.

### Example 40

According to this example there is provided a device comprising means to perform the method of any one of examples 26 to 32.

### Example 41

According to this example there is provided computer readable storage device having stored thereon instructions that when executed by one or more processors result in operations comprising: the method according to any one of examples 26 to 32.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A storage device controller, comprising:
storage device controller logic to:
receive an erase verify command from a host device; and
transmit an erase verification message to the host device, in response to the erase verify command; and
erase verification logic to:
access a secure erase log entry from access-limited memory locations in a non-volatile memory; and
secure the secure erase log entry with one or more cryptographic keys to generate the erase verification message.

2. The storage device controller of claim 1, wherein the storage device controller logic to:
receive a secure erase command from a host device;
erase host-accessible memory locations in the non-volatile memory;
generate the secure erase log entry; and
store the secure erase log entry in the access-limited memory locations in the non-volatile memory.

3. The storage device controller of claim 1, wherein the secure erase log entry includes metadata, wherein the metadata includes one or more of a timestamp, a size of memory locations the erased, or a number of secure erase operations performed.

4. The storage device controller of claim 1, wherein secure the secure erase log entry includes encrypt and/or sign the secure erase log entry, wherein the one or more cryptographic keys include at least one of a private signing key and a public encryption key, wherein the private signing key is to sign one or more portions of the erase verification message and is programmed into storage device controller firmware or programmed into fuses for a storage device during a manufacture of the storage device controller or the storage device, wherein the public encryption key is to encrypt one or more portions of the erase verification message.

5. The storage device controller of claim 1, wherein the one or more cryptographic keys and the erase verification logic are stored in the access-limited memory locations in the non-volatile memory.

6. The storage device controller of claim 1, wherein the erase verification logic is programmed into firmware of the storage device controller during a manufacture of the storage device controller.

7. The storage device controller of claim 1, wherein the erase verify command includes a nonce from the host device, wherein the erase verification message includes the nonce as evidence of an absence of replay attack compromise of the storage device controller.

8. The storage device controller of claim 1, wherein the erase verification logic secures the secure erase log entry by encrypting and/or signing the secure erase log using one or more of DES, Blowfish, AES, Twofish, IDEA, MD5, SHA1, HMAC, an elliptic curve direct anonymous attestation technique, or a Rivest-Shamir-Adleman (“RSA”) cryptographic technique.

9. The storage device controller of claim 1, wherein the erase verification message includes pre-erase data copied from host-accessible memory locations in the non-volatile memory and post-erase data copied from the host-accessible memory locations in the non-volatile memory.

10. A system, comprising:
a display; and
a storage device, including:
processor circuitry;
storage device buffer circuitry;
non-volatile memory having host-accessible memory locations and access-limited memory locations; and
a storage device controller communicatively coupled to the non-volatile memory, the storage device controller including:
storage device controller logic to:
receive an erase verify command from a host device; and
transmit an erase verification message to the host device, in response to the erase verify command; and
erase verification logic to:
access a secure erase log entry from the access-limited memory location in the non-volatile memory; and
secure the secure erase log entry with one or more cryptographic keys to generate the erase verification message.

11. The system of claim 10, wherein the storage device controller logic to:
receive a secure erase command from a host device;
erase host-accessible memory locations in the non-volatile memory;
generate the secure erase log entry; and
store the secure erase log entry in the access-limited memory locations in the non-volatile memory.

12. The system of claim 10, wherein the secure erase log entry includes metadata, wherein the metadata includes one or more of a timestamp, a size of memory locations the erased, or a number of secure erase operations performed.

13. The system of claim 10, wherein secure the secure erase log entry include encrypt and/or sign the secure erase log entry, wherein the one or more cryptographic keys include at least one of a private signing key and a public encryption key, wherein the private signing key is to sign one or more portions of the erase verification message and is programmed into storage device controller firmware or programmed into fuses for a storage device during a manufacture of the storage device controller or the storage device, wherein the public encryption key is to encrypt one or more portions of the erase verification message.

14. The system of claim 10, wherein the one or more cryptographic keys and the erase verification logic are stored in the access-limited memory locations in the non-volatile memory.

15. The system of claim 10, wherein the erase verification logic is programmed into firmware of the storage device controller during a manufacture of the storage device controller.

16. The system of claim 10, wherein the non-volatile memory is solid-state memory, hard disk media, or a combination of solid-state memory and hard disk media.

17. The system of claim 10, wherein the erase verification logic secures the secure erase log entry by encrypting and/or signing the secure erase log using one or more of DES, Blowfish, AES, Twofish, IDEA, MD5, SHA1, HMAC, an elliptic curve direct anonymous attestation technique, or a Rivest-Shamir-Adleman (“RSA”) cryptographic technique.

18. The system of claim 10, wherein the erase verification message includes pre-erase data copied from host-accessible memory locations in the non-volatile memory and post-erase data copied from the host-accessible memory locations in the non-volatile memory.

19. A computer readable storage device having stored thereon instructions that when executed by one or more processors result in operations, comprising:
receive an erase verify command from a host device;
access a secure erase log entry from access-limited memory locations in a non-volatile memory, wherein the access-limited memory locations are accessible by a storage device controller and are inaccessible by the host device;
secure the secure erase log entry with one or more cryptographic keys to form an erase verification message; and
transmit the erase verification message to the host device, in response to the erase verify command.

20. The computer readable storage device of claim 19, wherein the operations further include:
receive a secure erase command from a host device;
erase host-accessible memory locations in the non-volatile memory;
generate the secure erase log entry; and
store the secure erase log entry in the access-limited memory locations in the non-volatile memory.

21. The computer readable storage device of claim 19, wherein the secure erase log entry includes metadata, wherein the metadata includes one or more of a timestamp, a size of memory locations the erased, or a number of secure erase operations performed.

22. The computer readable storage device of claim 19, wherein the operations include:
read the one or more cryptographic keys from a plurality of fuses or from firmware for the storage device controller, wherein the one or more cryptographic keys include a private signing key and a public encryption key.

23. The computer readable storage device of claim 19, wherein secure the secure erase log entry includes:
copy the secure erase log entry to storage device buffer circuitry; and
apply the one or more cryptographic keys to the secure erase log entry to encrypt and/or
sign the secure erase log entry, using an encryption algorithm and/or a signing algorithm.

24. The computer readable storage device of claim 19, wherein the operations include:
receive a nonce from the host device with the erase verify command; and
include the nonce in the erase verification message, to enable the host to verify an absence of replay attack compromise of the storage device controller.

25. The computer readable storage device of claim 19, wherein secure the secure erase log entry includes use of one or more of DES, Blowfish, AES, Twofish, IDEA, MD5, SHA1, HMAC, an elliptic curve direct anonymous attestation technique, or a Rivest-Shamir-Adleman (“RSA”) cryptographic technique.
